(19) United States
(12) Patent Application Publication
(10) Pub. No.: US 2023/0392768 A1
(43) Pub. Date: Dec. 7, 2023

(54) HIGHLY EFFICIENT LIGHT EXTRACTION SYSTEM FOR LED CHIP ARRAYS

(71) Applicant: DICON FIBEROPTICS, INC., Richmond, CA (US)

(72) Inventors: Jeffrey B. Lee, Emeryville, CA (US); Tai-Chi Chu, Kaohsiung (TW); Yen-Chih Liu, Pingtung City (TW); Ho-Shang Lee, El Sobrante, CA (US)

(73) Assignee: DICON FIBEROPTICS, INC., Richmond, CA (US)

(21) Appl. No.: 17/887,939

(22) Filed: Aug. 15, 2022

Related U.S. Application Data
(60) Provisional application No. 63/349,741, filed on Jun. 7, 2022.

(51) Int. Cl. F21V 5/00; F21V 5/04

(52) U.S. Cl. CPC F21V 5/007; F21V 5/04

(57) ABSTRACT

A highly efficient light extraction system for LED chip arrays, in which a multi-function domed lens overlays the LED chip array. A lower portion of the multi-function domed lens acts as a reflector, capturing wide-angle light emitted by the LED chips. An upper portion of the multi-function domed lens provides the function of a refractive lens. The multi-function domed lens provides improved light extraction efficiency over prior art embodiments, greater total light output, as well as a narrower light distribution pattern, with increased light intensity at the center of the beam.

### PRIORITY CLAIM

This application claims the benefit of U.S. provisional patent application No. 63/349,741 filed Jun. 7, 2022, which is hereby incorporated in its entirety by this reference.

### BACKGROUND

The following is related generally to LED (light emitting diode) lighting systems using one or more arrays of high-brightness LED chips.

Prior art light extraction systems for LED arrays have generally followed one of two basic forms. In one prior art embodiment, an array of small simple lenses (for example, small half-ball lenses) overlays the LED chip array, with a one-to-one correspondence between individual lenses and individual LED chips. The diameter of each individual lens is comparable to the dimensions of a single LED chip. In another prior art embodiment, a single larger lens (for example, a large half-ball lens) overlays the entire LED chip array. Both of these prior art embodiments have disadvantages in terms of light extraction efficiency, as well as in the intensity of the light output of the system, especially at the center of the resulting light beam.

### SUMMARY

A highly efficient light extraction system for LED chip arrays includes a multi-function domed lens that overlays the LED chip array. Embodiments for the multi-function domed lens include a lower portion that acts as a reflector, capturing wide-angle light emitted by the LED chips, and an upper portion that provides the function of a refractive lens. The multi-function domed lens can provide improved light extraction efficiency, greater total light output, as well as a narrower light distribution pattern, with increased light intensity at the center of the beam. In the description that follows, the multi-function domed lens may also be referred to as a domed lens, dome-shaped lens, or simply as a dome lens.

### BRIEF DESCRIPTION OF THE DRAWINGS

FIG. 1A illustrates a prior art embodiment of a millimeter-scale lens array with a one-to-one correspondence to the LED chips in an underlying LED chip array.

FIG. 1B illustrates the side cross-sectional view of the prior art embodiment of FIG. 1A.

FIG. 2 illustrates a blow-up side view of a single LED light extraction unit, from the prior art embodiment of FIGS. 1A and 1B.

FIG. 3 illustrates another prior art embodiment of a light extraction system, using a single half-ball lens over an LED chip array.

FIG. 4A shows one embodiment using a single dome-shaped lens over an LED chip array.

FIG. 4B shows a perspective view of the dome-shaped lens embodiment.

FIG. 4C shows a perspective view of another embodiment with a rectangular footprint.

FIG. 5 shows a cluster of multiple LED light extraction systems, using the dome-shaped lenses of the embodiment of FIG. 4A over multiple LED chip arrays.

FIG. 6 is a flowchart to illustrate some embodiments for the forming of a dome-shaped lens over an LED chip array.

### DETAILED DESCRIPTION

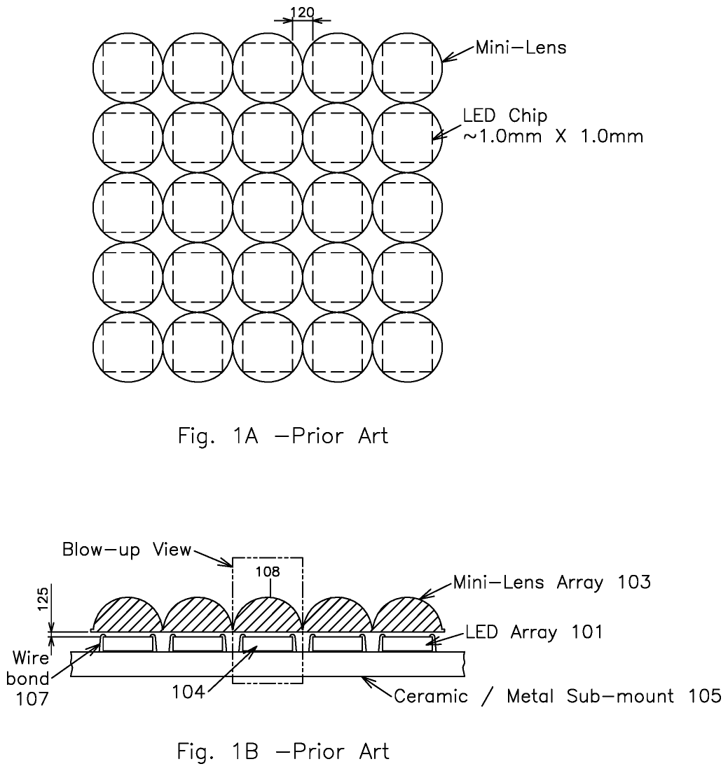

FIGS. 1A and 1B illustrate an example of a prior art embodiment of light extraction for a LED chip array 101, comprising an array of small, millimeter-scale lenses. The mini-lens array 103 is laid on the top of the LED chip array, with a one-to-one correspondence between individual lenses and individual LED chips. FIG. 1A provides a top view of the lighting system, and FIG. 1B provides a side, cross-sectional view of the lighting system. FIGS. 1A and 1B show a lighting system comprising 25 LED chips arranged as a 5×5 array, for explanatory purposes. FIG. 1A shows the dimensions of the individual LED chips as being 1.0 mm×1.0 mm, which is fairly typical for bare, unpackaged LED chips. The multiple LED chips are bonded on a sub-mount 105, whose material can be a ceramic, or metal, or a metal oxide. The electrical current for the LED chips is conducted through electrical paths on the sub-mount 105, as well as wire bonds 107 to the top surface of the LED chips in the LED array 101. As stated above, the size of a single LED chip 104 is typically on the order of a millimeter. To have high-intensity light output, the LED chips are kept as close to each other as possible. The gap 120 (shown in FIG. 1A) between two adjacent LED chips is typically smaller than the chip size (in this example, less than one millimeter). Thus, the diameter of the individual lens 108 is slightly bigger than that of an individual LED chip. As shown in FIG. 1B, there is a small gap 125, between the top surface of the LED chips, and the bottom surface of their corresponding lenses. This gap can be filled with a transparent material such as silicone gel, between the lens array and the LED chip array. In order to capture high-angle light rays from the LED chips, the gap is kept as small as possible, while also ensuring that the lens array does not touch the wire bonds 107.

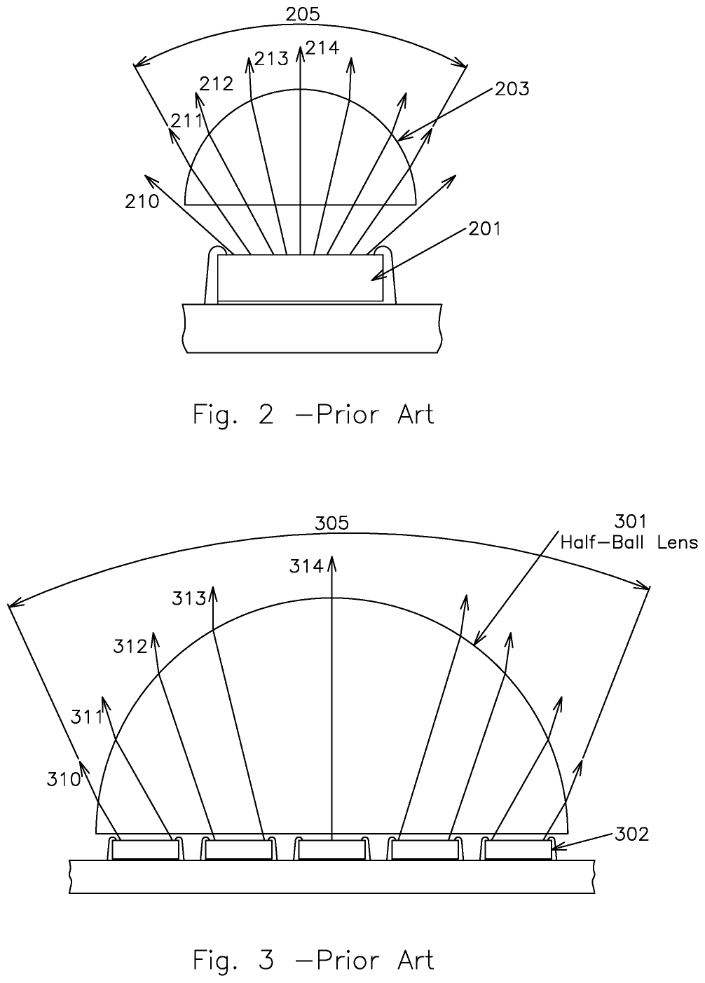

FIG. 2 provides a blow-up view of a single LED chip and its corresponding mini-lens, from prior art FIG. 1B. It illustrates how light rays from a single LED chip 201 are refracted by a single lens 203 to become a wide-angle light beam. Five rays are shown and labeled, to represent light rays emitted from the LED chip 201 at different angles, as well as from different positions on the surface of the LED chip. High-angle ray 210 is lost because the mini-lens 203 is unable to capture it. Rays 211 to 214, as well as the corresponding rays in the right-hand portion of the figure, form a light beam having a beam-spread angle (or beam angle) 205, of approximately 100 to 130 degrees, depending on the relative position or gap between the single LED chip and the single lens, as well as the lens size. The inability to capture high-angle rays such as ray 210 results in a loss of light extraction efficiency. The wide beam angle makes it difficult to achieve a high-intensity beam, especially at the center of the beam, even when secondary optical elements are used.

FIG. 3 illustrates another embodiment of a prior art light emission system. In this prior art embodiment, a single half-ball lens or a single convex lens 301 is shared by an LED array 302, to provide light extraction and partial collimation. This embodiment is typically used when the number of LED chips in the array is relatively large, generally more than 16 or 20 LED chips (i.e., for LED chip arrays larger than 4×4 arrays). Compared to the prior art embodiment of FIGS. 1A, 1B, and 2, the light loss of the high angle rays is reduced, as long as the half-ball lens 301 is brought close to the LED array 302. However, the resulting beam angle 305 is still large, and in the range of 110-130 degrees.

Typically, and by convention, the mini-lens array 103 of prior art FIG. 1B and the half-ball lens 301 of prior art FIG. 3 are referred to as the first optics of the lighting system, or as the primary optics. It is desirable that the total light output of the overall lighting system be as high as possible, and that the beam angle be as small as possible, so that the beam is more easily processed further by secondary optics, such as another convex lens, a Fresnel lens, or a condensing lens set, that further collimates the light beam. The following embodiment can help to better achieve this goal, providing greater light extraction efficiency, as well as a narrower, more intense beam from the first or primary optics.

More specifically, a highly efficient light extraction system for LED chip arrays uses a single-piece multi-function domed lens overlaying the LED chip array. A lower portion of the multi-function domed lens acts as a reflector, capturing wide-angle light emitted by the LED chips. This lower portion has a funnel, or inverted frustum, type of shape, being narrow at the bottom and increasing in size as it extends upward toward an upper portion of the lens. Light emitted from the LED is incident on the lower surface of the lower portion of the lens and the portions of this light incident on the sides of the lower portion are reflected toward the upper portion. The upper portion of the multi-function domed lens has a curved top surface that provides the function of a refractive lens. This lens structure provides improved light extraction efficiency over prior art embodiments, greater total light output, as well as a narrower light distribution pattern, with increased light intensity at the center of the beam.

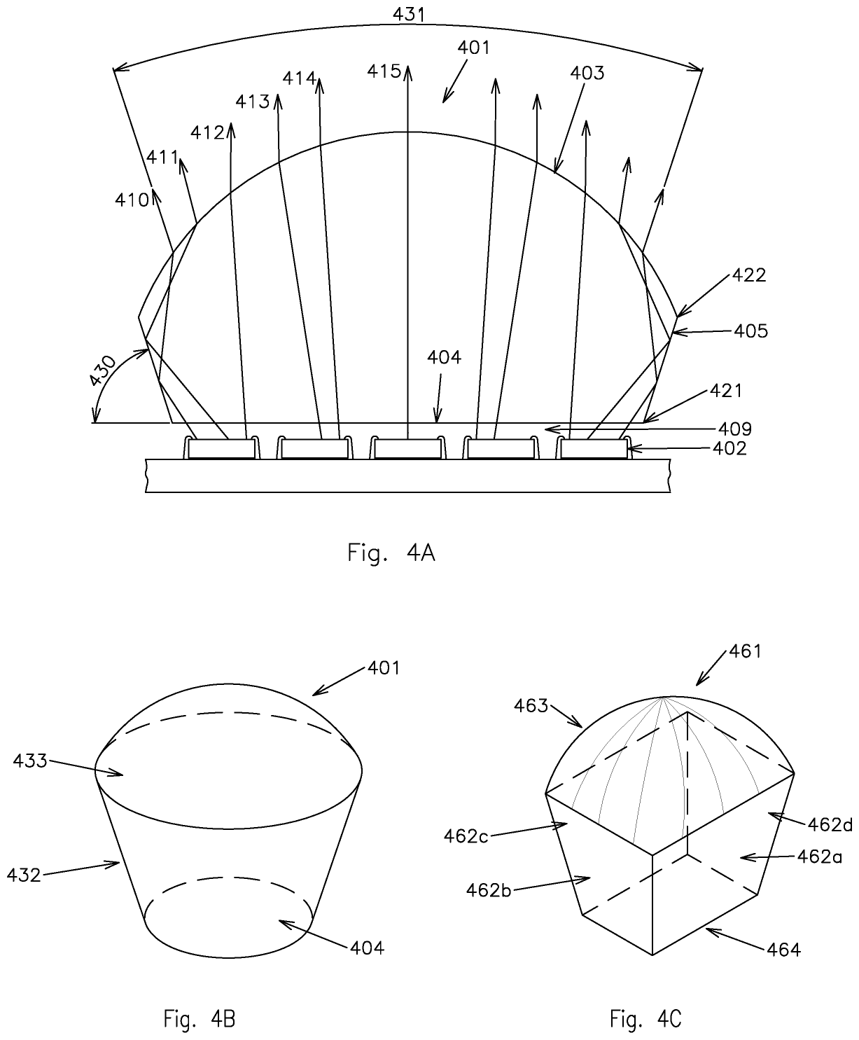

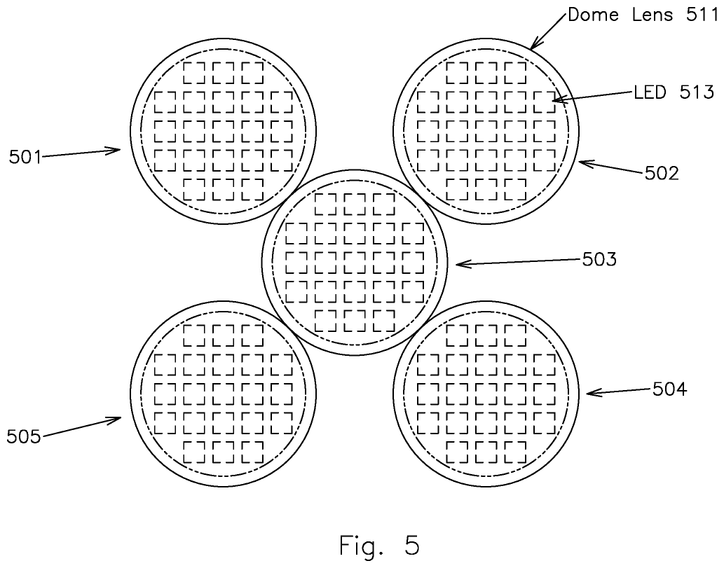

FIG. 4A illustrates one embodiment of an LED light emission system that uses a dome-shaped lens 401 for enhancing light extraction, with the domed lens being (in general) circularly symmetrical around the central ray 415. The dome-shaped lens 401 is overlaid on top of the LED chip array 402, which generally would have more than 16 or 20 individual LED chips (i.e., typically larger than a 4×4 LED chip array). The LED chip array 402 can be as described as above, with respect to FIGS. 1A, 1B, 2, and/or FIG. 3. FIG. 4A shows a cross-section view of the LED light emission system, and FIG. 4B is a perspective view of the domed lens 401 itself. The dome-shaped lens 401 has a top surface 403 with a profile or shape that is the same as, or is similar to, that of a conventional convex lens. However, the single piece dome-shaped lens 401 also has a side-surface 405. It is this side-surface 405 of the lens' lower portion that first captures and reflects the high-angle rays emitted from the LED chips of LED chip array 402. For example, the capturing and reflecting of high-angle rays from the left-most LED chip in FIG. 4A, is represented by rays 410 and 411. These high-angle rays are reflected by the inside of side surface, and are then re-directed via refraction out of upper surface 403, as part of the forward light beam. The use of both a reflective side surface, as well as a refractive upper portion, is why the dome-shaped lens may also be referred to as a “multi-function domed lens”.

The diameter of the bottom surface (or edge) 421 of the side surface 405 is designed to be substantially smaller than the diameter of the side surface at its top surface (or edge) 422. Thus, in FIG. 4A, the tilt-up angle 430 (the angle between the side surface 405 and a line that extends from the plane of the bottom surface of the lens 404) can be designed to range from approximately 35 to 60 degrees. Through the use of this dome-shaped lens (or multi-function domed lens) 401, the beam angle 431 is reduced significantly to 80-90 degrees, and therefore the central lux or light intensity is greatly increased by more than 50%, as compared to the case of the prior art half-ball lens system shown in FIG. 3. Furthermore, by adjusting the tilt-up angle 430, the overall light output and the resulting beam profile (intensity vs. illuminated angle) can be varied.

Furthermore, it is not necessary for the bottom surface 404 of the lens 401 to be a circle. In other embodiment it can be an oval, a square, a rectangle, a hexagon or other non-circular shapes as long as they have an angled side surface 405 (or, multiple angled side surfaces, when the bottom surface is a square, rectangle or some other polygonal shape), to reflect the high-angle rays to the top surface 403. The non-circular bottom surface 404 could have advantages of shaping the intensity profile of the output beam to a desired intensity distribution or beam shape, and enhancing color mixing in the output beam if multiple colors of LED chips are implemented in the LED chip array 402. FIG. 4C illustrates a perspective view of a “multi-function dome lens” 461 having a rectangular bottom surface 464. There are four side surfaces 462a, b, c and d, each of which are angled out from the bottom surface 464. The top surface 463 has a curved shape that is convex similar to a circular convex lens, but with different profile due to the rectangular shape. More generally, the lower portion can have the shape of an inverted truncated pyramid, or frustum, with the lower surface of the lower portion expanding toward the upper internal surface where the lower portion meets the convex topped upper portion. The cross-section of the funnel of the frustum can be circular as in FIGS. 4A and 4B, rectangular as in FIG. 4C, or other shapes such as elliptical, oval, or other polygonal shape. In some embodiments the cross-section can change, such as being rectangular at the bottom surface and becoming circular where it meets the upper portion. FIGS. 4A-4C illustrate a right frustum, in with the axis of the frustum is orthogonal to the plane of the LED chip array, but in other embodiments the axis can be angled relative to the surface.

The reflection of wide-angle rays at the side surface 405 is the result of total internal reflection. Thus, although the deposition of an additional reflective coating layer on the outside of the side surface 405 is not required, in some embodiments a metal layer, or a dielectric thin film coating, or other reflective coating, can be applied on the outside of the side surface 405 to improve its reflectivity over a wider range of incident angles. In some embodiments, a transparent material such as silicone gel can be added to fill the gap 409 between the bottom surface 404 of the dome-shaped lens 401 and the LED chips 402 to enhance light extraction from the LED chips 402, as well as to reduce Fresnel reflection at the bottom surface 421 of the dome-shaped lens.

The dome-shaped lens 401 can be formed by glass molding, followed by additional polishing of upper surface 403, bottom surface 404, and side surface(s) 405, if necessary. In some embodiments, the single-piece lens 401 can be manufactured by grinding from a cylindrical or other shape of rod, after an appropriate length of the rod has been sliced. In other embodiments, the dome-shaped lens structure can be assembled from multiple pieces for ease of manufacturing. For example, the top portion 433 and the conic section 432 as illustrated in FIG. 4B can be manufactured separately and then bonded them together by transparent adhesives or glass fusion to form the single piece lens structure.

Example of the materials for embodiments of the multi-function domed lens can include optically transparent materials, such as borosilicate glass, fused silica, silicone, acrylic, plastic materials or other optically transparent materials.

FIG. 5 illustrates another embodiment in which a multiple of the LED array light emission units (as shown individually in FIG. 4A) are clustered together. For example, five LED array units 501, 502, 503, 504 and 505 are shown in FIG. 5. The dome-shaped lenses 511 are only slightly larger than the effective diameter of each of the LED array units, such that they allow the LED array units (501 to 505) to cluster closely, until the dome-shaped lenses touch one another. The dome-shaped lens over each of the LED array units can have the circular form facto of the embodiment of FIGS. 4A and 4B or other cross-sectional shape for improved density of packing, such a square or rectangular shape with flat edges along where the lenses for the different LED array units meet, or such as a hexagonal shape for a dense packing of many LED array units in a honeycomb sort of arrangement. The total light output and intensity of the cluster shown in FIG. 5 is multiple times that of an individual LED array light emission unit, such as 501.

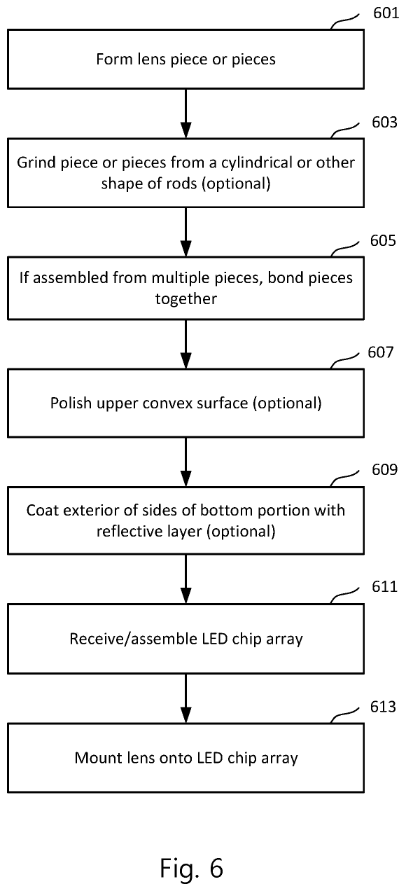

FIG. 6 is a flowchart to illustrate some embodiments for the forming of a dome-shaped len over an LED chip array. Beginning at step 601, the lens or lens pieces are formed either as a single piece, either using a method such as glass molding, or grinding the desired shape from a cylindrical or other shape of rod, or as separate pieces corresponding to what will become the upper and lower portions. The piece or piece can be formed of optically transparent materials, such as the above-mentioned borosilicate glass, fused silica, silicone, acrylic, or plastic materials, for example. Step 603 is an optional step for when the piece or pieces of the lens are not formed to the dome-shaped lens and when a cylindrical or other shape of rod or rods can be ground to shape. Step 605 is an optional step in which, when the lens is assembled from multiple pieces, these pieces are bonded together by transparent adhesives or glass fusion, for example, to form the single piece lens structure.

Once the dome-shaped lens is formed in step 601 and, in some embodiments, one or both of steps 603 and 605, in some embodiments the dome-shaped upper surface can be polished (or further polished) in step 607. Similarly, at 609, to improve the reflectivity of the sides of the lower frustrum region over a wider range of incident angles, in some embodiments the outer surface of the sides of the lower portion can be coated with a reflective material such as a metal layer, a dielectric thin film, or some other form of reflective coating. Although here step 609 follows 607, it can be performed earlier. Once the single piece lens is complete it can then be mounted onto an LED chip array. At step 611, the LED chip array is either received or assembled, such as by mounting the individual LEDS on a sub-mount and forming the wire bonds. Step 611 can be performed at any point prior to step 613. As step 613 the lens is bonded or otherwise mounted on to the LED chip array, where in some embodiments the gap between the lens and the LED chip array can be filled with a silicone gel or other transparent material. Multiple such individual lens/LED chip arrays can then be assembled into a cluster, as illustrated in FIG. 5 for example, depending on the application.

In summary, the single piece multi-function domed lens, with its reflective side surface and refractive upper portion, can provide improvements in light extraction efficiency, total light output, and also a narrower beam angle with resulting greater light intensity, compared to the prior art in LED array primary optics.

In a first set of aspects, an optical device includes a single piece lens formed of an optically transparent material and configured to mount over a plurality of light emitting diodes (LEDs) of a LED chip array. The lens includes: an upper portion having a dome-shaped top surface configured to transmit light emitted from the LEDs that is incident thereupon; and a lower portion having a bottom surface upon which the light emitted from the LEDs is incident, the lower portion having an inverted frustum shape increasing in size from the bottom surface towards the upper portion and having sides angled to reflect light incident thereon through the bottom surface towards the dome-shaped top surface.

Other aspects include a method of forming an optical device that comprises forming a single piece lens of an optically transparent material and configured to mount over a plurality of light emitting diodes (LEDs) of a LED chip array. The forming a single piece lens includes: forming an upper portion having a dome-shaped top surface configured to transmit light emitted from the LEDs that is incident thereupon; and forming a lower portion having a bottom surface upon which the light emitted from the LEDs is incident, the lower portion having an inverted frustum shape increasing in size from the bottom surface towards the upper portion and having sides angled to reflect light incident thereon through the bottom surface towards the dome-shaped top surface.

For purposes of this document, reference in the specification to “an embodiment,” “one embodiment,” “some embodiments,” or “another embodiment” may be used to describe different embodiments or the same embodiment.

For purposes of this document, a connection may be a direct connection or an indirect connection (e.g., via one or more other parts). In some cases, when an element is referred to as being connected or coupled to another element, the element may be directly connected to the other element or indirectly connected to the other element via intervening elements. When an element is referred to as being directly connected to another element, then there are no intervening elements between the element and the other element. Two devices are “in communication” if they are directly or indirectly connected so that they can communicate electronic signals between them.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify different objects.

For purposes of this document, the term “set” of objects may refer to a “set” of one or more of the objects.

The foregoing detailed description has been presented for purposes of illustration and description. It is not intended to be exhaustive or to limit to the precise form disclosed. Many modifications and variations are possible in light of the above teaching. The described embodiments were chosen in order to best explain the principles of the proposed technology and its practical application, to thereby enable others skilled in the art to best utilize it in various embodiments and with various modifications as are suited to the particular use contemplated. It is intended that the scope be defined by the claims appended hereto.

1. An optical device, comprising:
a single piece lens formed of an optically transparent material and configured to mount over a plurality of light emitting diodes (LEDs) of a LED chip array, the lens comprising:
an upper portion having a dome-shaped top surface configured to transmit light emitted from the LEDs that is incident thereupon; and
a lower portion having a bottom surface upon which the light emitted from the LEDs is incident, the lower portion having an inverted frustum shape increasing in size from the bottom surface towards the upper portion and having sides angled to reflect light incident thereon through the bottom surface towards the dome-shaped top surface.

2. The optical device of claim 1, wherein the frustum shape is a right circular frustum.

3. The optical device of claim 1, wherein the frustum shape is a rectangular frustum.

4. The optical device of claim 1, wherein the single piece lens is formed as a single piece.

5. The optical device of claim 1, wherein the single piece lens is formed of a plurality of joined pieces.

6. The optical device of claim 1, further comprising:
a silicone gel filling a gap region between the single piece lens and the LED chip array.

7. The optical device of claim 1, further comprising:
a reflective coating on an outer surface of sides of the lower portion of the single piece lens.

8. The optical device of claim 1, wherein the single piece lens is borosilicate glass.

9. The optical device of claim 1, wherein the single piece lens is fused silica.

10. The optical device of claim 1, wherein the single piece lens is silicone.

11. The optical device of claim 1, wherein the single piece lens is acrylic.

12. The optical device of claim 1, wherein the single piece lens is a plastic material.

13. The optical device of claim 1, wherein the single piece lens is a glass material.

14. The optical device of claim 1, further comprising:
the LED chip array comprising the plurality of LEDs mounted on a sub-mount and configured to emit light in an upward direction.

15. A method of forming an optical device, comprising:
forming a single piece lens of an optically transparent material and configured to mount over a plurality of light emitting diodes (LEDs) of a LED chip array, including:
forming an upper portion having a dome-shaped top surface configured to transmit light emitted from the LEDs that is incident thereupon; and
forming a lower portion having a bottom surface upon which the light emitted from the LEDs is incident, the lower portion having an inverted frustum shape increasing in size from the bottom surface towards the upper portion and having sides angled to reflect light incident thereon through the bottom surface towards the dome-shaped top surface.

16. The method of claim 15, wherein the upper portion and the lower portion are formed as a single piece.

17. The method of claim 15, wherein the upper portion and the lower portion are formed separately, the method further comprising:
bonding together the upper portion and the lower portion.

18. The method of claim 15, wherein forming a single piece lens comprises:
grinding the upper portion and the lower portion from a rod.

19. The method of claim 15, further comprising:
polishing the dome-shaped top surface.

20. The method of claim 15, further comprising:
coating an exterior surface of sides of the lower portion with a reflective material.
